(19) United States
(12) Patent Application Publication
(10) Pub. No.: US 2024/0330631 A1
(43) Pub. Date: Oct. 3, 2024

(54) IMAGE FORMING APPARATUS AND IMAGE FORMING SYSTEM

(71) Applicant: CANON KABUSHIKI KAISHA, Tokyo (JP)

(72) Inventor: TAKUMA YASUKAWA, Chiba (JP)

(21) Appl. No.: 18/608,732

(22) Filed: Mar. 18, 2024

(30) Foreign Application Priority Data
Mar. 30, 2023 (JP) 2023-054864

(51) Int. Cl. G06K 15/02; G03G 15/00; G03G 15/01; G06K 15/00

(52) U.S. Cl. CPC G06K 15/1868; G03G 15/01; G03G 15/5016; G06K 15/002; G06K 15/1876; G06K 15/1882; G06K 15/408

(57) ABSTRACT

An image forming apparatus capable of performing color erasing print processing using a color erasable recording material, the image forming apparatus includes a receiving interface (IF) configured to receive a print job, and a notification IF configured to notify of information. The image forming apparatus causes, in a case where the receiving IF has received a print job for the color erasing print processing, and a printing content of print data contained in the print job for the color erasing print processing does not satisfy a condition, the notification IF to notify of a warning for the color erasing print processing.

### BACKGROUND

### Field of the Disclosure

The present disclosure relates to an image forming apparatus and an image forming system.

### Description of the Related Art

In recent years, the Sustainable Development Goals (SDGs) has increased environmental consciousness. Image forming apparatuses can contribute to the SDGs through reuse of printed sheets. More specifically, an image forming apparatus, as discussed in Japanese Patent Application Laid-Open No. 2018-072809, for example, has been known to be applicable not only to printing with a normal toner but also to printing with a color erasable toner with which printed sheets become reusable.

Japanese Patent Application Laid-Open No. 2018-072809 discusses a method for processing a sheet printed with a color erasable toner by using a color erasing apparatus, to erase the color erasable toner, whereby the user can reuse the sheet.

### SUMMARY

According to an aspect of the present disclosure, an image forming apparatus capable of performing color erasing print processing using a color erasable recording material, the image forming apparatus includes a receiving interface (IF) configured to receive a print job, a notification IF configured to notify of information, and a controller having one or more processors which executes instructions stored in one or more memories, the controller being configured to cause, in a case where the receiving IF has received a print job for the color erasing print processing, and a printing content of print data contained in the print job for the color erasing print processing does not satisfy a condition, the notification IF to notify of a warning for the color erasing print processing.

Further features of the present disclosure will become apparent from the following description of embodiments with reference to the attached drawings.

### BRIEF DESCRIPTION OF THE DRAWINGS

FIG. 1 is a block diagram illustrating a configuration of an image forming apparatus.

FIG. 2 is a diagram illustrating an example configuration of controller software.

FIG. 3 is a diagram illustrating examples of output results of bitmap data and attribute values.

FIG. 4 is a diagram illustrating an example of print description language (PDL) data.

FIG. 5 is a diagram illustrating an example of a configuration of the PDL data.

FIG. 6 is a diagram illustrating an example of an association table for color erasing restriction conditions and adjustment processing.

FIGS. 7A and 7B are diagrams illustrating examples of user notification screens for results of the adjustment processing.

FIGS. 8A and 8B are diagrams illustrating examples of user selection screens for the adjustment processing.

FIGS. 9A and 9B are diagrams illustrating an example of a control flowchart for image adjustment and user notification.

FIG. 10 is a block diagram illustrating a configuration of an image processing system including a personal computer (PC).

FIG. 11 is a diagram illustrating an example of a software configuration of the PC.

FIGS. 12A and 12B are diagrams illustrating another example of a control flowchart for image adjustment and user notification.

FIG. 13 is a block diagram illustrating a configuration of the PC.

FIGS. 14A and 14B are diagrams illustrating yet another example of a control flowchart for image adjustment and user notification.

FIGS. 15A and 15B are diagrams illustrating yet another example of a control flowchart for image adjustment and user notification.

### DESCRIPTION OF THE EMBODIMENTS

embodiments of the present disclosure will be described in detail with reference to the accompanying drawings. The following embodiments are not intended to limit the disclosure according to the appended claims, and not all combinations of features described in the embodiments are necessarily mandatory to the means for solving the problems of the present disclosure. In the present embodiment, an image forming apparatus is described as an example of an information processing apparatus.

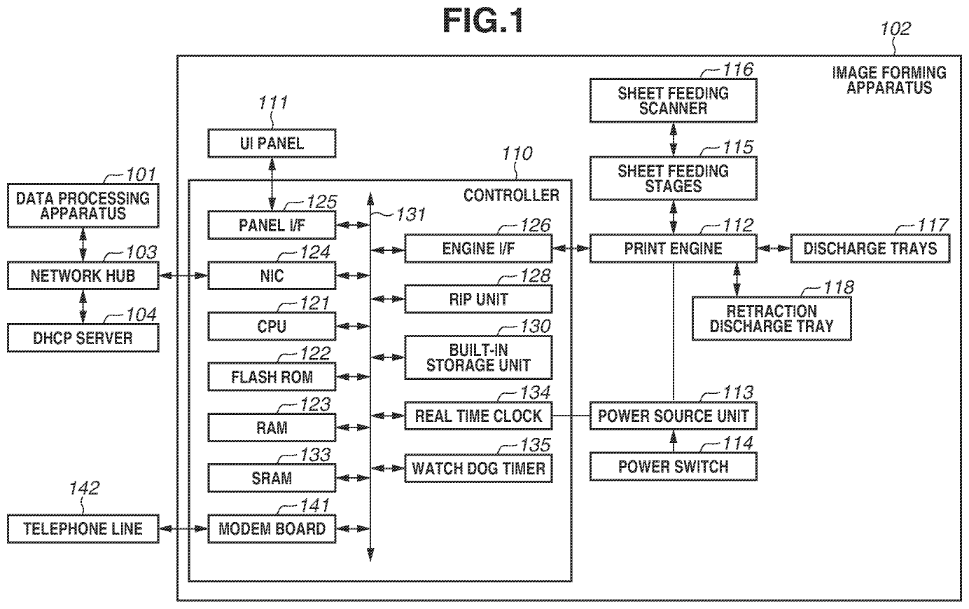

The image adjustment and user notification on the main body of an image forming apparatus 102 will be described below with reference to FIG. 1.

FIG. 1 is a block diagram schematically illustrating a configuration of the image forming apparatus 102 according to the present embodiment. In FIG. 1, the image forming apparatus 102 is connected with a data processing apparatus 101 and a dynamic host configuration protocol (DHCP) server 104 via a network hub 103.

The network hub 103 performs data communication between the data processing apparatus 101, the image forming apparatus 102, and the DHCP server 104. The present embodiment will be described below centering on a local network configuration in which the data processing apparatus 101, the image forming apparatus 102, and the DHCP server 104 are connected to the single hub, the network hub 103. However, the configuration is not limited thereto. For example, other network configurations using a plurality of network hubs are also applicable.

The data processing apparatus 101 is, for example, a personal computer (PC) that generates print description language (PDL) data and transmits the PDL data to the image forming apparatus 102. In processing for firmware update of the image forming apparatus 102, the data processing apparatus 101 transmits compressed data for the firmware update of the image forming apparatus 102 to the image forming apparatus 102. The DHCP server 104 receives a request for acquisition of network setting information based on the dynamic host configuration protocol (DHCP) and transmits the network setting information as a response.

The image forming apparatus 102 is, for example, a laser printer that receives PDL data from the data processing apparatus 101 and forms an image on a sheet based on the received image data. The image forming apparatus 102 may be a multi-function peripheral having a plurality of functions, such as a copy function, a scanner function, and a facsimile function. The image forming apparatus 102 includes a controller 110, a user interface (UI) panel 111, a print engine 112, a power source unit 113, and a power switch 114.

The controller 110 is a controller board that generates bitmap data for printing based on PDL data received from the data processing apparatus 101 and transmits the bitmap data to the print engine 112. To print settings and conditions related to the image forming apparatus 102 as a report, the controller 110 itself is also able to generate PDL data and issue a print instruction.

The UI panel 111 includes a display unit (not illustrated) to notify the user of various information and an operation unit (not illustrated) to receive various operations from the user. For example, the UI panel 111 may include a touch panel in addition to physical buttons. The image forming apparatus 102 may have a function of lighting up or blinking the light emitting diodes (LEDs) on the UI panel 111 and notifying the user of an error or warning occurring in the image forming apparatus 102. The image forming apparatus 102 may also have a function of generating a warning beep sound from the UI panel 111 and notifying the user of an error or warning occurring in the image forming apparatus 102.

The print engine 112 forms an image on a sheet through an electrophotographic method, based on the bitmap data received from the controller 110. Examples of applicable image forming methods include not only an electrophotographic method using a toner as a recording material but also an ink jet method using ink as a recording material. In this case, the “output toner type”, “normal toner”, and “color erasable toner” according to the present embodiment can be replaced with “output ink type”, “normal ink”, and “color erasable ink”, respectively. The print engine 112 may be configured to include recording materials of a plurality of colors to enable color printing. The print engine 112 may be configured to include a plurality of discharge trays 117 and a retraction discharge tray 118 for discharging a sheet without printing. Further, the print engine 112 may be configured to include a plurality of sheet feeding stages 115 and feed a sheet from a sheet feeding stage specified in the PDL data from among the plurality of sheet feeding stages 115.

The color erasable toner is a composite toner that becomes transparent with application of heat at temperatures above a predetermined level, so that the toner is erased. More specifically, the color erasing temperature of toner is set to be higher than the fixing temperature in fixing processing. For example, in a case where the fixing temperature of the normal toner (non-color erasable toner) is 120° C., the color erasing temperature of the color erasable toner is designed to be 140° C. while the description will be made centering on a toner as an example of a recording material, the recording material may be color erasable ink that is erased with heat at temperatures above a certain level.

A color erasing print function (color erasing print processing) refers to print processing relating to the above-described color erasable toner. Unlike for a print product printed with a normal non-color erasable toner, the color erasing print function erases an image formed on a print product, which enables the sheet to be reusable. A print product with a color erasable toner can be used in a similar way to a normal print product as long as the color erasing print function (described below) is not applied to the product.

The color erasing print function is disposed as a function of the image forming apparatus 102 or as an independent apparatus. The color erasing print function changes an image formed on a recording medium, such as a sheet, with a color erasable toner to an invisible image or a hardly visible image so that the image appears as if it erased. Changing to an invisible image is referred to as decoloring (making transparent) the image formed with the color erasable toner. In decoloring, the image forming apparatus 102 controls the heat to be applied to a sheet by using a component (fixing member) for the fixing processing (processing in which the highest temperature is applied to the toner in the print processing) in the print processing. More specifically, in color erasing processing, the image forming apparatus 102 sets the temperature of the fixing member to 140° C. or higher. Then, by using the heated fixing member, the image forming apparatus 102 heats the sheet with an image formed with the color erasable toner to erase the image on the sheet.

According to a first embodiment, a color erasing print job is referred to as a print job with the color erasing print function (color erasing print processing) set to ON.

In the present embodiment, the print engine 112 has a function of switching the output toner type to be used in image formation on a sheet between the normal toner (non-color erasable toner) and the color erasable toner according to an instruction from the controller 110. The print engine 112 has a function of adjusting parameters of the image formation process, such as the sheet conveyance speed and the fixing temperature, based on an output toner type. For example, the print engine 112 changes the fixing temperature between printing with the normal toner and printing with the color erasable toner. In printing with the color erasable toner, the print engine 112 records a mark indicating the number of times of printing with the color erasable toner outside the printing target region on the printing target sheet. The sheet feeding stages 115 include a sheet feeding scanner 116 for scanning a fed sheet. This enables the image forming apparatus 102 to detect a mark or feature indicating the number of times of printing performed with the color erasable toner for use in processing.

The power source unit 113 is a power unit for supplying electric power to the components of the image forming apparatus 102. The power source unit 113 has a role of generating voltages for operation of the components and supplying the voltages to the components. The power switch 114 receives a power ON instruction and a power OFF instruction from the user. For example, in response to the user pressing the power switch 114 during power OFF of the image forming apparatus 102, a power switch pressing event is notified to the power source unit 113. The power source unit 113 starts supplying power to the components of the image forming apparatus 102.

The controller 110 includes a central processing unit (CPU) 121, a flash read only memory (ROM) 122, a random access memory (RAM) 123, a static RAM (SRAM) 133, a network interface controller (NIC) 124, and a panel interface (I/F) 125. The controller 110 also includes an engine I/F 126, a raster image processor (RIP) unit 128, a built-in storage unit 130, and a real time clock 134. The controller 110 further includes a watch dog timer 135, and a modem board 141 for communication via a telephone line 142. The controller 110 further includes a bus 131 connecting these components.

The CPU 121, a central processing unit, executes various programs to control the image forming apparatus 102. The flash ROM 122 is a non-volatile memory for storing an initial program to be executed by the CPU 121 upon reset releasing as a trigger. The RAM 123 is a volatile memory for storing temporary information during operation of the CPU 121 operating various programs. The SRAM 133 is a volatile memory for storing data during power ON of the image forming apparatus 102.

The NIC 124, a network interface controller, interconnects the image forming apparatus 102 and a device outside the image forming apparatus 102 via a network to relay data communication, i.e., data transmission and reception, between the image forming apparatus 102 and the device. According to the present embodiment, the image forming apparatus 102 may include a wireless communication unit in addition to a wired communication unit.

The panel I/F 125 interconnects the UI panel 111 and the controller 110 to relay data communication, i.e., data transmission and reception, between the UI panel 111 and the controller 110.

The engine I/F 126 interconnects the print engine 112 and the controller 110 to relay data communication, i.e., data transmission and reception, between the print engine 112 and the controller 110.

The RIP unit 128 converts intermediate data into bitmap data and rasterizes the bitmap data in the RAM 123. The present embodiment has been described above centering on a configuration in which the RIP unit 128, which is dedicated and independent of the CPU 121, converts the intermediate data into bitmap data. However, the image forming apparatus 102 does not necessarily need to include the RIP unit 128. In a configuration in which the image forming apparatus 102 does not include the RIP unit 128, the CPU 121 performs processing for converting the PDL data received from the data processing apparatus 101 into bitmap data.

The built-in storage unit 130 is a nonvolatile storage device for storing an Operating System (OS) to be activated from the initial program. The built-in storage unit 130 is, for example, an embedded Multi Media Card (eMMC), a hard disk drive, or a solid state drive. The built-in storage unit 130 can secure a mass-storage area at a relatively low cost. Thus, the OS program and data to be used by the OS are stored in the built-in storage unit 130. The built-in storage unit 130 can also be used for a hold printing function with which a received print job is once held and then printing of the held job is performed after the adjustment of the image quality and density via the UI panel 111.

A real time clock 134 is a hardware chip for management of time information in the image forming apparatus 102 in a nonvolatile way. The real time clock 134 is driven by power supplied from a battery serving as a power source independent of the power source unit 113. Thus, the time information can be periodically updated even after power of the image forming apparatus 102 is turned OFF.

The modem board 141 transmits and receives a FAX job as a reception-time print job to and from a FAX apparatus of the image forming apparatus 102 via the telephone line 142.

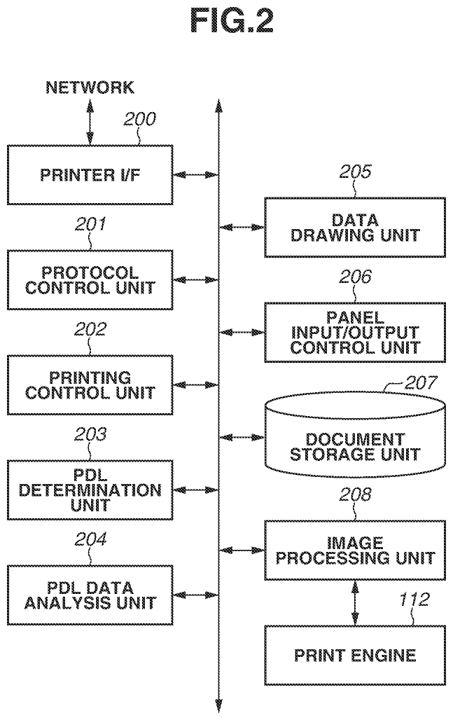

FIG. 2 is a block diagram illustrating a configuration of controller software that controls operation of the image forming apparatus 102. A printer interface 200 controls inputs and outputs with an external apparatus via the NIC 124. A protocol control unit 201 analyzes and transmits a network protocol to communicate with an external apparatus. The printer interface 200 receives PDL data transmitted from an external network and then stores the data in a document storage unit 207.

A print control unit 202 causes the CPU 121 to perform activation processing of a PDL determination unit 203 and a PDL analysis unit 204 in response to the PDL data that has been received and stored in the document storage unit 207.

The PDL determination unit 203 causes the CPU 121 to analyze the PDL data according to an instruction of the print control unit 202 and determine the PDL type and the file format type. The PDL analysis unit 204 is means with which the CPU 121 analyzes the PDL data selected by the PDL determination unit 203 and converts the data into intermediate data (display list) for each drawing object having an easily processable format. Examples of drawing objects include characters (text objects), graphics (graphic objects), and photographs (image objects). The intermediate data generated by the PDL analysis unit 204 is transferred to a data drawing unit 205 via the document storage unit 207.

The data drawing unit 205 causes the RIP unit 128 to successively draw bitmap data, based on the intermediate data stored in the document storage unit 207, and store the bitmap data in the document storage unit 207.

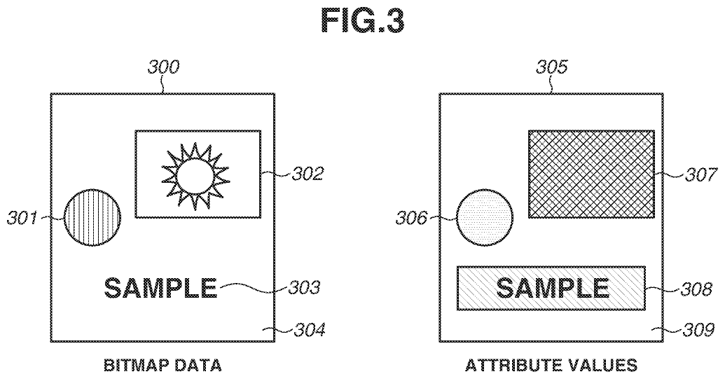

FIG. 3 is a diagram illustrating information about bitmap data 300 and attribute values 305 output by the data drawing unit 205. The bitmap data 300 can be divided into four different attributes: an image 302, a graphic image 301, a text 303, and a background 304. The image 302 is a raster image represented by a photograph. The graphic image 301 is a vector image represented by a graphic. The background 304 is bitmap data other than the image 302, the graphic image 301, and the text 303.

The PDL data can be classified based on PDL commands and, in analysis of the PDL data by the PDL analysis unit 204, the classified data is set to intermediate data as attribute values. PDL commands indicating images, graphics, and fonts or characters are specified by a printer driver which is to be described below. The RIP unit 128 sets the background 304 as a default attribute in a case where specification from among the image 302, the graphic image 301, and the text 303 is not performed. The data drawing unit 205 draws image region information like the attribute values 305 for each attribute of the bitmap data 300. The attribute values 305 include an attribute 307 of the image 302, an attribute 306 of the graphic image 301, an attribute 308 of the text 303, and an attribute 309 of the background 304. The attribute values 305 are 8-bit data items output for each pixel. For example, a text region, a graphic region, and an image region are output as 0x0A, 0x04, and 0x08, respectively. With this configuration, the attribute values 305 is able to be used in detection of which coordinate regions of bitmap data is a location where a text, a graphic, or an image is printed.

The data drawing unit 205 draws bitmap data in the 24-bit red, green, and blue (RGB) format and generates the attribute values 305 as 8-bit data items on a pixel basis. The data drawing unit 205 transmits the image region information for the attribute values 305 indicating drawing regions of different drawing objects on a print region to an image processing unit 208. While, in the present embodiment, the attribute values 305 specify image regions on a pixel basis, the present disclosure is not limited thereto. The attribute values 305 may be acquired based on coordinate positional information. The data drawing unit 205 outputs each of the attribute values 305 in an 8-bit data size, the data size is not fixed but can be changed by a PDL data job.

A panel input/output control unit 206 controls inputs and outputs from the panel I/F 125 via the UI panel 111. The document storage unit 207 stores data files including PDL data and intermediate data in units of a group (job) of input documents. The document storage unit 207 is implemented by secondary storage devices, such as the RAM 123 and the built-in storage unit 130.

The image processing unit 208 reads the bitmap data and the image region information generated by the data drawing unit 205, from the document storage unit 207 for use in processing. In the present embodiment, the image processing unit 208 can calculate a printing ratio with respect to the entire region, for example, based on a sum total value of drawing target pixels. The image processing unit 208 can also calculate an image data size based on drawing regions for the attribute 307 of the image and the attribute 306 of the graphic image.

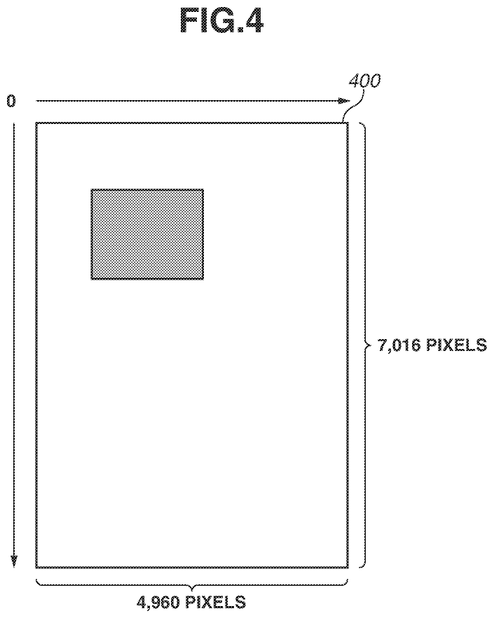

FIG. 4 is a diagram illustrating an example of PDL data. In PDL data 400, a square is drawn on a sheet for which A4 (210 mm×297 mm) is specified as the paper size (Media) and Portrait (with vertical long sides) is specified as the page orientation (Orientation).

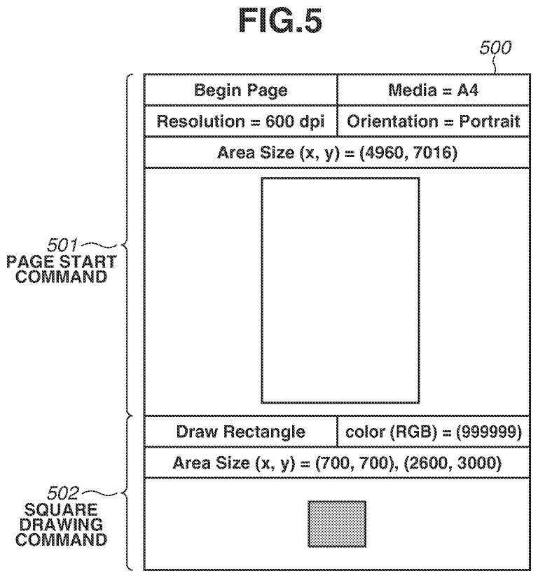

FIG. 5 is a diagram illustrating configuration details of the PDL data illustrated in FIG. 4. The PDL data includes a page start (layout) command 501 and a square drawing command 502. The page start (layout) command 501 contains a resolution (Resolution), a paper size (Media), a page orientation (Orientation), and a width and a height of the bitmap data to be generated (Area Size).

The resolution (Resolution) is set to 600 dots per inch (dpi). The paper size (Media) is set to A4 (210 mm×297 mm). The page orientation (Orientation) is set to Portrait. In this case, the width and height of formed bitmap data (AreaSize) are set to 4,960 pixels×7,016 pixels, respectively. The square drawing command 502 contains a color specification and a drawing region indicating start and end points in the horizontal and vertical directions. Based on these pieces of detailed information, the image processing unit 208 can obtain a printing ratio with respect to the entire page and the size of each image for the PDL data received as a job.

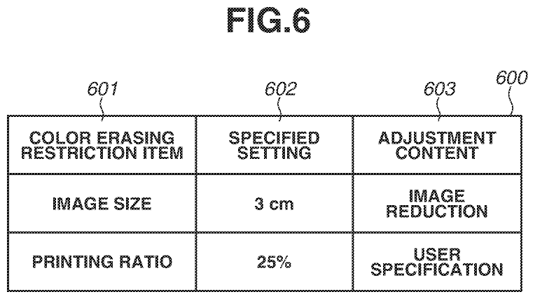

FIG. 6 is a diagram illustrating an example of the relations between color erasing restriction conditions and processing to be performed when a job not satisfying the restriction conditions is entered. A color erasing restriction item 601 indicates printing items serving (print contents) as color erasing restriction conditions for a color erasing apparatus. The examples illustrated in FIG. 6 indicate that there are restrictions on the image size and printing ratio. A specified setting 602 indicates specific predetermined settings for the color erasing restriction item 601.

In the case illustrated in FIG. 6, a length of 3 cm or less of an image and a printing ratio of 25% or below are the restriction conditions. An adjustment content 603 indicates contents to be adjusted in a case where a job does not satisfy the restriction conditions in accordance with the color erasing restriction item 601 and the specified setting 602. In the example case illustrated in FIG. 6, in a case where the image has a length exceeding 3 cm, the image is reduced before printing. Also, in a case where the printing ratio exceeds 25%, the adjustment content is determined by a user specification. These restrictions may be, for example, restrictions for an independent color erasing apparatus as illustrated or restrictions for a case where the image forming apparatus 102 has the color erasing print function, which can be specified by the user. While, in the present embodiment, the preset adjustment content is performed with respect to the image size, the image size may be specified by the user like the printing ratio. While, in the present embodiment, the printing ratio is specified by the user, the preset adjustment content may be performed with respect to the printing ratio, like the image size.

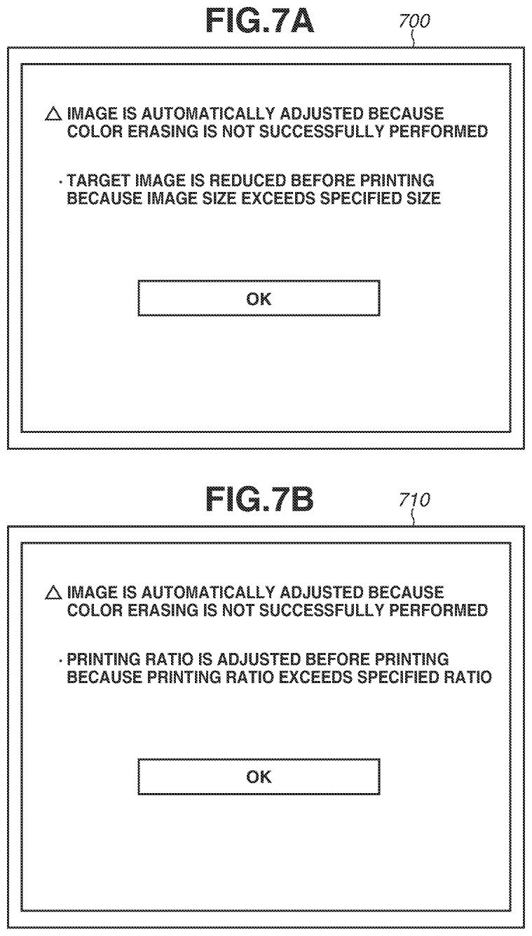

FIGS. 7A and 7B are diagrams illustrating examples of user notification screens displaying processing results in a case where a job not satisfying the color erasing restriction conditions illustrated in FIG. 6 has been entered. A screen 700 illustrated in FIG. 7A notifies the user of a warning that the image size exceeds a specified size. The screen 700 illustrated in FIG. 7A further notifies the user that the target image partially has a length exceeding 3 cm and thus is reduced to fit into a size satisfying the restriction conditions before printing.

A screen 710 illustrated in FIG. 7B displays a notification notifying the user of a warning that the printing ratio exceeds a predetermined ratio. The screen 710 illustrated in FIG. 7B also displays a notification notifying the user that the printing ratio exceeds the predetermined ratio and is adjusted to fit into a ratio satisfying the restriction conditions by adjusting the resolution and the character thickness.

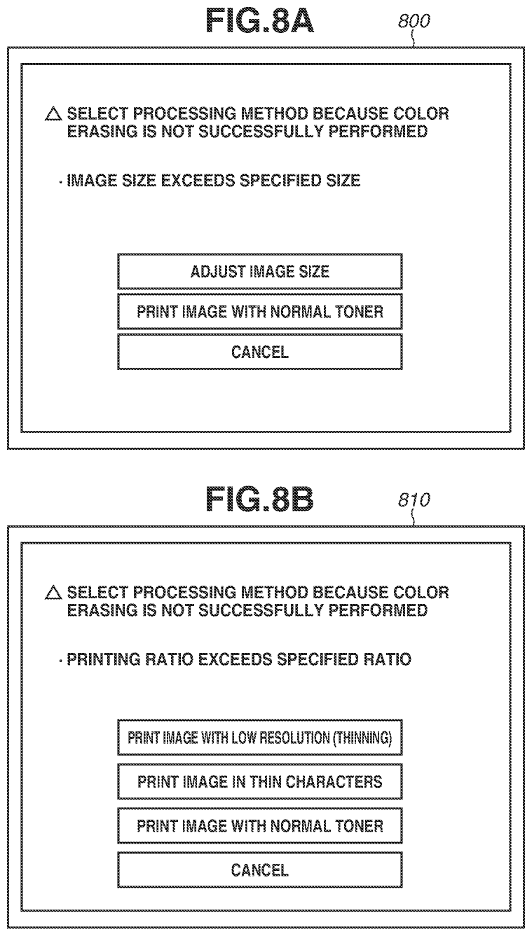

FIGS. 8A and 8B are diagrams illustrating examples of user selection menu screens displayed in a case where a job not satisfying the color erasing restriction conditions illustrated in FIG. 6 has been entered.

A processing selection menu 800 illustrated in FIG. 8A notifies the user of a warning that the image size exceeds the specified size. On the processing selection menu 800 illustrated in FIG. 8A, the user selects a processing method from among items, ADJUST IMAGE SIZE, PRINT IMAGE WITH NORMAL TONER, and CANCEL. The item ADJUST IMAGE SIZE specifically refers to reduction of the image size.

A processing selection menu 810 illustrated in FIG. 8B notifies the user of a warning that the printing ratio exceeds the predetermined ratio. For example, on a condition that a restriction condition indicated by the adjustment content 603 is a printing ratio specified by the user, the user selects a processing method from among items, PRINT IMAGE WITH LOW RESOLUTION (THINNING), PRINT IMAGE IN THIN CHARACTERS, PRINT IMAGE WITH NORMAL TONER, and CANCEL on the processing selection menu 810 illustrated in FIG. 8B. In a case where the image forming apparatus 102 reduces the number of print pixels or thins characters to be printed to perform image thinning, the image processing unit 208 performs the adjustment on the image. In printing the image with a normal toner, the image processing unit 208 changes the toner type from the color erasable toner to the normal toner and instructs the print engine 112 to perform printing. In cancellation of the job, the image processing unit 208 notifies the print control unit 202 to cancel the job without instructing the print engine 112 to perform printing.

Although, in FIGS. 8A and 8B, a warning and options are displayed at the same time, a warning screen may be displayed before a selection screen.

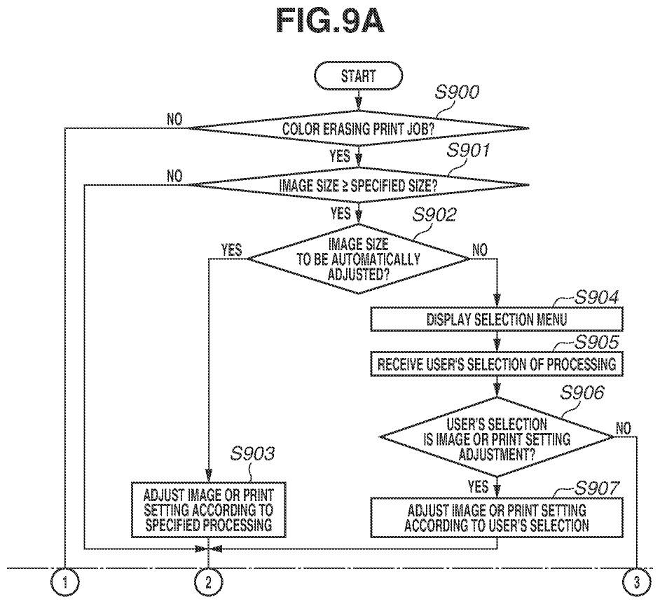

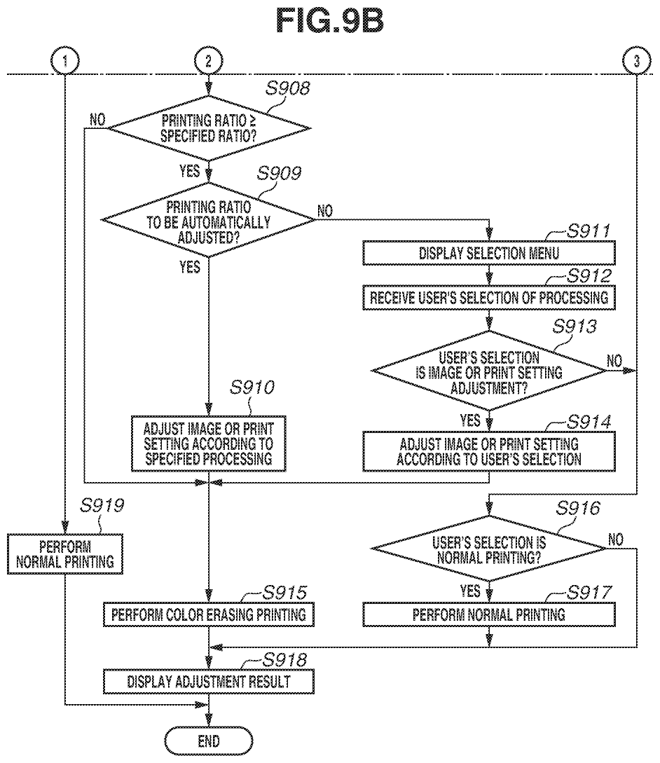

FIGS. 9A and 9B are diagrams illustrating an example of a control flowchart for the image adjustment and user notification in the image forming apparatus 102. In response to the image forming apparatus 102 receiving a job from the user, the CPU 121 causes the image processing unit 208 to analyze the image.

In step S900, the CPU 121 causes the image processing unit 208 to determine whether the job has the setting of the color erasing print function. In a case where the image processing unit 208 determines that the job has the setting of the color erasing print function (YES in step S900), the processing proceeds to step S901. In a case where the image processing unit 208 determines that the job does not have the setting of the color erasing print function (NO in step S900), the processing proceeds to step S919.

In step S901, the CPU 121 causes the image processing unit 208 to check whether the image size of the job is equal to or larger than the specified size. More specifically, the CPU 121 checks for each page whether an image having a length exceeding 3 cm exists in bitmap data having the attribute 307 of the image 302 and in bitmap data having the attribute 306 of the graphic image 301. Because one inch equals 25.4 mm, in the case of 600 dpi, for example, the CPU 121 determines that an image having a length exceeding 3 cm exists if the attribute 307 of the image 302 or the attribute 306 of the graphic image 301 indicates 7,087 or more contiguous pixels.

In step S902, the CPU 121 causes the image processing unit 208 to check whether the image size is to be automatically adjusted. In other words, the CPU 121 determines whether the adjustment content 603 of the image size does not indicate USER SPECIFICATION but indicates specific processing. In a case where the CPU 121 determines that the image size is to be automatically adjusted (YES in step S902), the processing proceeds to step S903. In a case where the CPU 121 determines that the image size is not to be automatically adjusted (NO in step S902), the processing proceeds to step S904. While, in the example in FIG. 6, the adjustment content of the image details is predetermined, the CPU 121 may display a selection menu to prompt the user to select normal printing or cancellation like steps S904 to S907, S916, and S917 (described below).

In step S903, the CPU 121 causes the image processing unit 208 to adjust the image according to the adjustment content in FIG. 6 and then displays the screen 700 illustrated in FIG. 7A. The screen 700 notifies the user that the image size of the job is equal to or larger than the specified size and that the color erasing print job has not been successfully performed.

While, in this example, the CPU 121 performs size reduction of the print image as the image adjustment, the CPU 121 may adjust the print setting by selecting printing with the normal toner depending on the image size. In a case where the image is to be adjusted, an image satisfying the restriction conditions can be formed. The image forming apparatus 102 may be configured to hold a job in the built-in storage unit 130 to allow the user to edit the job via the UI panel 111 of the image forming apparatus 102.

In step S904, the CPU 121 causes the panel input/output control unit 206 to display a processing selection menu 800 illustrated in FIG. 8A and waits until the user selects processing.

In step S905, the CPU 121 receives a selection of user desired processing via the processing selection menu 800 illustrated in FIG. 8A from the user.

In step S906, the CPU 121 causes the panel input/output control unit 206 to check whether the processing selected by the user is an item for adjustment of an image or print setting. In a case where the panel input/output control unit 206 determines that the processing selected by the user is the item for adjustment of an image or print setting (YES in step S906), i.e., in a case where the item ADJUST IMAGE SIZE, is selected, the processing proceeds to step S907. In a case where the panel input/output control unit 206 determines that the processing selected by the user is not the item for adjustment of an image or print setting (NO in step S906), i.e., in a case where the item PRINT IMAGE WITH NORMAL TONER or the item CANCEL is selected, the processing proceeds to step S916. The item ADJUST IMAGE SIZE specifically refers to image size reduction.

In step S907, the CPU 121 causes the image processing unit 208 to adjust the image or print setting according to the user's selection.

In step S908, the CPU 121 causes the image processing unit 208 to check whether the printing ratio of the job is equal to or larger than a specified ratio. More specifically, for example, the CPU 121 checks for each page whether the printing ratio of the job exceeds 25%. The printing ratio of a job is, for example, the ratio of bitmap data having the attribute 307 of the image 302, bitmap data having the attribute 306 of the graphic image 301, and bitmap data having the attribute 308 of the text 303, to the entire bitmap data. In a case of the 600 dpi resolution, bitmap data of an A4 size is 4,960×7,016 pixels. Thus, for example, the CPU 121 determines that the printing ratio exceeds 25% if the attribute 308 of the text 303 is 8,700 or more pixels. In a case where the image processing unit 208 determines that the printing ratio of the job is equal to or larger than the specified ratio (YES in step S908), the processing proceeds to step S909. In a case where the image processing unit 208 determines that the printing ratio of the job is less than the specified ratio (NO in step S908), the processing proceeds to step S915.

In step S909, the CPU 121 causes the image processing unit 208 to check whether the printing ratio is to be automatically adjusted. In other words, determination of whether the adjustment content 603 of the printing ratio indicates not USER SPECIFICATION but specific processing. In a case where the image processing unit 208 determines that the printing ratio is to be automatically adjusted (YES in step S909), the processing proceeds to step S910. In a case where the image processing unit 208 determines that the printing ratio is not to be automatically adjusted (NO in step S909), the processing proceeds to step S911.

In step S910, the CPU 121 causes the image processing unit 208 to adjust the image according to the specified processing and displays the screen 710 in FIG. 7B. The screen 710 notifies the user that the printing ratio of the job is equal to or larger than the specified ratio and that the color erasing print job has not been successfully performed. While, in the present embodiment, the user selects processing, any item may be performed as specified processing.

In step S911, the CPU 121 causes the panel input/output control unit 206 to display the processing selection menu 810 illustrated in FIG. 8B and waits until the user selects processing.

In step S912, the CPU 121 receives a selection of desired processing displayed in the processing selection menu 810 from the user.

In step S913, the CPU 121 causes the panel input/output control unit 206 to determine whether the processing selected by the user is the item PRINT IMAGE WITH LOW RESOLUTION (THINNING) or the item PRINT IMAGE IN THIN CHARACTERS. In a case where the panel input/output control unit 206 determines that the processing selected by the user is the item PRINT IMAGE WITH LOW RESOLUTION (THINNING) or the item PRINT IMAGE IN THIN CHARACTERS (YES in step S913), the processing proceeds to step S914. In a case where the panel input/output control unit 206 determines that the processing selected by the user is the item other than the item PRINT IMAGE WITH LOW RESOLUTION (THINNING) and the item PRINT IMAGE IN THIN CHARACTERS (NO in step S913), the processing proceeds to step S916. As long as the printing ratio is to be decreased, other settings may also be applicable.

In step S914, the CPU 121 causes the image processing unit 208 to adjust the image or print setting according to the user's selection. In a case where the image adjustment is selected, an image satisfying the restriction conditions can be expected.

In step S915, the CPU 121 causes the image processing unit 208 to perform color erasing printing via the print engine 112. While, in the present embodiment, the color erasing printing is performed, the configuration may be applicable in such a manner that the sheet feeding scanner 116 scans a fed sheet and the number of times of printing with the color erasable toner is less than a predetermined number, the CPU 121 prints the image. On the other hand, in a case where the number of times of printing is equal to or larger than the predetermined number, the sheet may be discharged to the retraction discharge tray 118 without printing. With this configuration, a sheet with a favorable condition suitable for reuse can be assigned to a job.

In step S916, the CPU 121 causes the panel input/output control unit 206 to check whether the processing selected by the user is the normal print processing (PRINT IMAGE WITH NORMAL TONER). In a case where the panel input/output control unit 206 determines that the processing selected by the user is the normal print processing (YES in step S916), the processing proceeds to step S917. In a case where the panel input/output control unit 206 determines that the processing selected by the user is not the normal print processing (NO in step S917), the processing proceeds to step S918. The determination of the normal printing is performed based on the fact that the color erasing print processing is not set.

In step S917, the CPU 121 causes the image processing unit 208 to perform the normal print processing via the print engine 112.

In step S918, the CPU 121 causes the panel input/output control unit 206 to notify the user of a result of the adjustment. With this configuration, the user can check what adjustment has been performed in a case where the job does not satisfy the specified restriction conditions. For example, in a case where the sheet feeding scanner 116 scans a fed sheet and the number of times of printing with the color erasable toner is equal to or larger than the predetermined number, the CPU 121 may not notify the user of a result of the adjustment because an efficient operation has been performed. In this case, the CPU 121 may display a result of the adjustment before steps S915 and S917.

In step S919, the CPU 121 causes the image processing unit 208 to perform the normal print processing via the print engine 112.

As described above, in the present embodiment, adjustment of the image or print setting is automatically or selectively performed for a job having specified restriction conditions so that the job can be processed as a job satisfying the specified restriction conditions. This prevents the user from unintentionally entering a job not satisfying the specified restriction conditions, which leads to operation with an expectation for the efficient reuse of sheets by a color erasing apparatus.

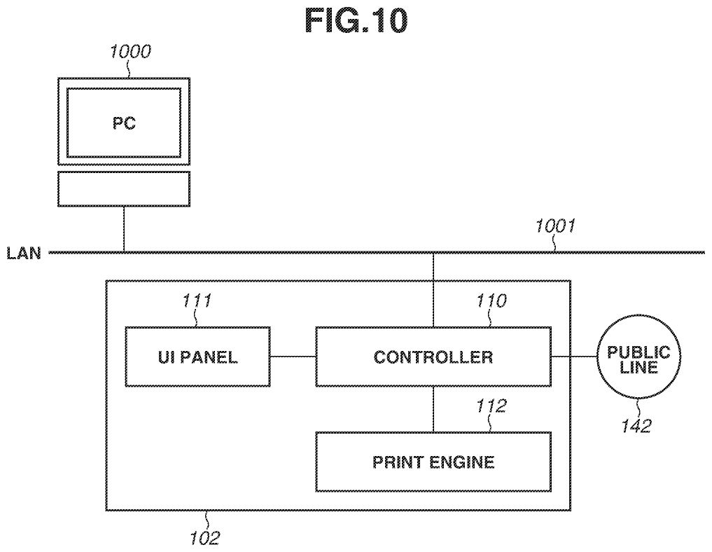

The image adjustment and user notification on the main body of a host computer (hereinafter referred to as a PC) 1000 according to a second embodiment will be described below with reference to FIG. 10.

FIG. 10 is a block diagram illustrating a configuration of an image processing system according to the present embodiment. In the image processing system according to the present embodiment, the PC 1000 and the image forming apparatus 102 are connected to a local area network (LAN) 1001. However, the number of connections is not limited thereto. While, in the present embodiment, a LAN is used as a connection method, the present disclosure is not limited thereto. Examples of applicable transmission methods include any network, such as a wide area network (WAN) (public line), a serial transmission method such as universal serial bus (USB), and a parallel transmission method such as Centronics and small computer system interface (SCSI).

The PC 1000 has functions of a personal computer. The basic internal configuration of the PC 1000 will be described below. Hardware components of the PC 1000 include a CPU, a RAM, a ROM, a hard disk drive (HDD), input devices such as a keyboard and a mouse, output devices such as a display unit, a network interface (I/F), and a chip set for controlling these components. These components are connected with each other by an internal data bus.

A basic input/output system (BIOS) and an operation system (OS) are operating as software for controlling above-described hardware components. The PC 1000 is capable of transmitting and receiving files and E-mails by using the file transfer protocol (FTP) and the server message block (SMB) protocol via the LAN 1001 or a WAN.

The PC 1000 is also capable of instructing the image forming apparatus 102 to perform printing via a printer driver.

The image forming apparatus 102 includes the print engine 112 as an image output device, the controller 110 for controlling entire operation of the image forming apparatus 102, and the UI panel 111 as a user interface (UI).

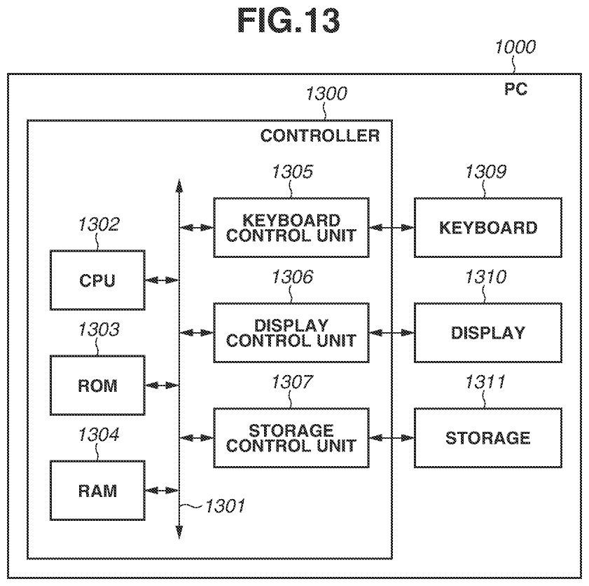

FIG. 13 is a diagram illustrating an example of a configuration of the host computer serving as an example of a print control apparatus. The PC 1000 includes a controller 1300, and the controller 1300 includes a CPU 1302, a ROM 1303, a RAM 1304, a keyboard control unit 1305, a display control unit 1306, a storage control unit 1307. The PC 1000 further includes a keyboard 1309, a display 1310, and a storage 1311.

The CPU 1302, a central processing unit, controls entire operation of various apparatuses connected to a system bus 1301. The CPU 1302 performs document processing incorporating graphics, images, texts, and tables (including spreadsheets) based on applications programs, such as a document processing program stored in the ROM 1303 (described below) or the storage 1311. The CPU 1302 also performs processing for rasterizing outline fonts, for example, into a display information RAM set on the RAM 1304. This enables implementing a function of printing an image with the same size and shape settings as those of the image displayed on the display 1310.

The CPU 1302 opens various registered windows based on commands specified with the mouse cursor (not illustrated) on the display 1310, and performs various data processing. When the user prints an image by using the image forming apparatus 102, the user opens a print setting window to perform settings of the image forming apparatus 102 and settings of a print processing method for the printer driver including a print mode selection.

The RAM 1304 functions as the main memory and a work area for the CPU 1302. The ROM 1303 stores font data, programs, and document data. The storage 1311 stores the operating system (hereinafter referred to as an OS) which is the control program of the CPU 1302.

The keyboard control unit 1305 controls key inputs from the keyboard 1309 and a pointing device (not illustrated). The display control unit 1306 controls display of the display 1310. The storage control unit 1307 controls access to the storage 1311. The PC 1000 is connected to the image forming apparatus 102 via the LAN 1001 and performs processing for controlling communication with the image forming apparatus 102. The keyboard 1309 includes various keys.

The display 1310 displays graphics, images, texts, tables, and so on. The storage 1311 includes a solid state drive (SSD), a hard disk drive (HD), and a floppy disk drive (FD). The storage 1311 stores a boot program, various applications, font data, user files, editing files, and printer control command generation programs (hereinafter referred to as printer drivers).

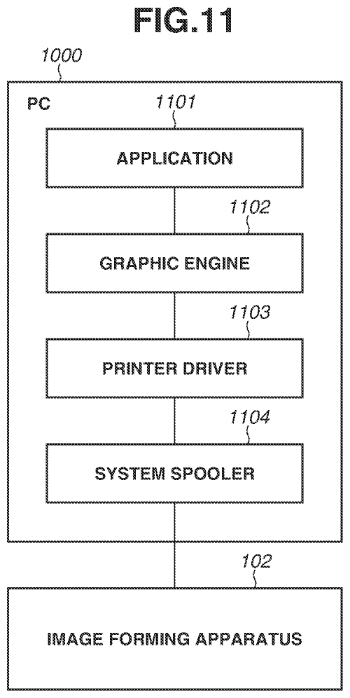

FIG. 11 is a diagram illustrating a functional configuration outline related to print processing in the host computer serving as a print control apparatus that issues a print instruction to the image forming apparatus 102 connected via a network. The print processing is started when the user of the host computer issues a print instruction from an application 1101, such as a word processor program or spreadsheet program.

The application 1101 analyzes application data including text drawing data and calls, for example, a graphic engine 1102 provided by the operating system (OS).

The graphic engine 1102 loads the printer driver 1103 prepared according to the type of the image forming apparatus 102 and delivers the output of the application 1101 to the printer driver 1103. Then, the graphic engine 1102 converts the GraphicDeviceInterface (GDI) function received from the application 1101 into the DeviceDriverInterface (DDI) function and outputs the DDI function to the printer driver 1103. In the print processing, a document includes a plurality of pages each including a plurality of DDIs, and various parameters for drawing are delivered to the printer driver 1103.

The printer driver 1103 converts the DDI function received from the graphic engine 1102 into a printer-recognizable control command, e.g., a PDL command. The converted printer control command is output to the image forming apparatus 102 as print data via an interface represented by the LAN 1001, for example, via a system spooler 1104. Print information received from the DDI by the printer driver 1103 has three different attributes: “text” as font information, “graphic” including a graphic vector and gradation information, and “image” such as a photographic scan image. Data having the “image” attribute includes such information as the number of pixels in the vertical and horizontal directions and the output image size. Thus, as for data having the “image” attribute, the printer driver 1103 can easily determine the image size based on the printing ratio with respect to the entire page and the data having the “image” attribute at a timing when the print information from the DDI is received.

The image forming apparatus 102 interprets the control command, rasterizes the command into bitmap data, and eventually outputs a printing result to a recording medium, such as paper. The above-described method including replacing each drawing instruction from the OS with the corresponding PDL command and transmitting the command to a printer is referred to as a PDL mode. There is also a different mode in which the printer driver 1103 rasterizes the entire page into bitmap data (rendering) and transmitting the data to a printer (hereinafter this mode is referred to as a raster mode). In the raster mode, rendered data is represented in the 24-bit RGB format.

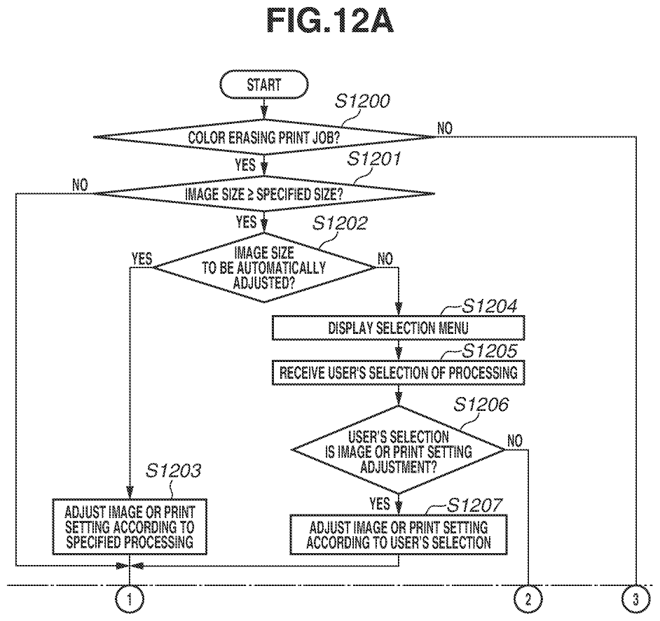

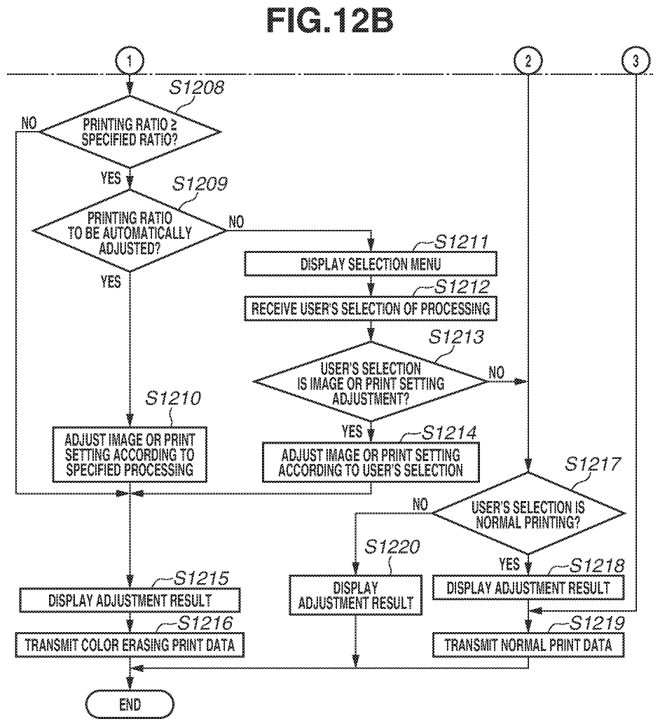

FIGS. 12A and 12B are diagrams illustrating an example of a control flowchart of the image adjustment and user notification that are performed in the PC 1000. In the PC 1000, the printer driver 1103 receives print data from the application 1101, analyzes the image, and adds a print setting to the print data to generate a print job.

In step S1200, the printer driver 1103 checks whether to add the setting of the color erasing print function to the print job. In a case where the printer driver 1103 determines to add the setting of the color erasing print function to the print job (YES in step S1200), the processing proceeds to step S1201. In a case where the printer driver 1103 determines not to add the setting of the color erasing print function to the print job (NO in step S1200), the processing proceeds to step S1219.

In step S1201, the printer driver 1103 checks whether the image size of the print data to be included in the print job is equal to or larger than the specified size. More specifically, the printer driver 1103 renders the received print data in the raster mode and stores the bitmap data in the RAM 1304. Then, the printer driver 1103 checks for each page whether any piece of data with the image or graphic attribute has a length exceeding 3 cm. Because one inch equals 25.4 mm, in the case of 600 dpi, the printer driver 1103 determines that an image having a length exceeding 3 cm exists if the image or graphic attribute is 7,087 or more contiguous pixels). In a case where the printer driver 1103 determines that the image size of the print data to be included in the print job is equal to or larger than the specified size, (YES in step S1201), the processing proceeds to step S1202. In a case where the printer driver 1103 determines that the image size of the print data to be included in the print job is less than the specified size, (NO in step S1201), the processing proceeds to step S1204.

In step S1202, the printer driver 1103 checks whether the image size is to be automatically adjusted. In other words, the printer driver 1103 determines whether the adjustment content 603 of the image size does not indicate USER SPECIFICATION but indicates specific processing. In a case where the printer driver 1103 determines that the image size is to be automatically adjusted (YES in step S1202), the processing proceeds to step S1203. In a case where the printer driver 1103 determines that the image size is not to be automatically adjusted (NO in step S1202), the processing proceeds to step S1204. While, in the example in FIG. 6, the adjustment content of the image details is predetermined, the printer driver 1103 may display a selection menu to prompt the user to select normal printing or cancellation in steps S1204 to S1207 and S1217 to S1220 which are described below.

In step S1203, the printer driver 1103 adjusts the image according to the adjustment content illustrated in FIG. 6 and then displays the screen 700 in FIG. 7A. While, in the present embodiment, the printer driver 1103 performs size reduction of the print image as the image adjustment, the printer driver 1103 may adjust the print setting, for example, by selecting printing with the normal toner depending on the image size. In a case where the image is to be adjusted, an image satisfying the restriction conditions can be expected. The printer driver 1103 may be configured to change the job to a user-editable hold printing job via the UI panel 111 of the image forming apparatus 102.

In step S1204, the printer driver 1103 displays the processing selection menu 800 illustrated in FIG. 8A on the display (not illustrated) of the PC 1000 and waits until the user selects processing.

In step S1205, the printer driver 1103 receives a selection of desired processing via the processing selection menu 800 illustrated in FIG. 8A from the user.

In step S1206, the printer driver 1103 determines whether the processing selected by the user is the image or print setting adjustment. In a case where the printer driver 1103 determines that the processing selected by the user is the image or print setting adjustment (YES in step S1206), i.e., in a case where the item ADJUST IMAGE SIZE is selected, the processing proceeds to step S1207. In a case where the printer driver 1103 determines that the processing selected by the user is the item other than the image or print setting adjustment (NO in step S1206), i.e., in a case where the item PRINT IMAGE WITH NORMAL TONER or the item CANCEL is selected, the processing proceeds to step S1217.

In step S1207, the printer driver 1103 adjusts the image or print setting according to the user's selection.

In step S1208, the printer driver 1103 checks whether the printing ratio of the print data is equal to or larger than the specified ratio. More specifically, for example, the printer driver 1103 checks for each page whether the printing ratio of the print data exceeds 25%. The printing ratio of the print data is, for example, the ratio of bitmap data having the attribute 307 of the image 302, bitmap data having the attribute 306 of the graphic image 301, and bitmap data having the attribute 308 of the text 303 to the entire bitmap data. In a case of the 600 dpi resolution, bitmap data of an A4 size is 4,960×7,016 pixels. Thus, for example, the printer driver 1103 determines that the printing ratio exceeds 25% if the attribute 308 of the text 303 is 8,700 or more pixels. In a case where the printer driver 1103 determines that the printing ratio of the print data is equal to or larger than the specified ratio (YES in step S1208), the processing proceeds to step S1209. In a case where the printer driver 1103 determines that the printing ratio of the print data is less than the specified ratio (NO in step S1208), the processing proceeds to step S1215.

In step S1209, the printer driver 1103 checks whether the printing ratio is to be automatically adjusted. In other words, the printer driver 1103 determines whether the adjustment content 603 of the printing ratio does not indicate USER SPECIFICATION but indicates specific processing. In a case where the printer driver 1103 determines that the printing ratio is to be automatically adjusted (YES in step S1209), the processing proceeds to step S1210. In a case where the printer driver 1103 determines that the printing ratio is not to be automatically adjusted (NO in step S1209), the processing proceeds to step S1211.

In step S1210, the printer driver 1103 adjusts the image according to the specified processing and displays the screen 710 illustrated in FIG. 7B. While, in the present embodiment, the user selects processing, any item may be performed as specified processing.

In step S1211, the printer driver 1103 displays the processing selection menu 810 illustrated in FIG. 8B on the display (not illustrated) of the PC 1000 and waits until the user selects processing.

In step S1212, the printer driver 1103 receives a selection of desired processing in the processing selection menu 810 from the user.

In step S1213, the printer driver 1103 determines whether the processing selected by the user is the item PRINT IMAGE WITH LOW RESOLUTION (THINNING) or the item PRINT IMAGE IN THIN CHARACTERS. In a case where the printer driver 1103 determines that the processing selected by the user is the item PRINT IMAGE WITH LOW RESOLUTION (THINNING) or the item PRINT IMAGE IN THIN CHARACTERS (YES in step S1213), the processing proceeds to step S1214. In a case where the printer driver 1103 determines that the processing selected by the user is an item other than the item PRINT IMAGE WITH LOW RESOLUTION (THINNING) and the item PRINT IMAGE IN THIN CHARACTERS (NO in step S1213), the processing proceeds to step S1217.

In step S1214, the printer driver 1103 adjusts the image or print setting according to the user's selection. In a case where the image adjustment is selected, an image satisfying the restriction conditions can be expected.

In step S1215, the printer driver 1103 notifies the user of a result of the adjustment on the display (not illustrated) of the PC 1000. With this configuration, the user can check what adjustment has been performed in a case where the job does not satisfy the specified restriction conditions.

In step S1216, the printer driver 1103 instructs the image forming apparatus 102 to perform color erasing printing.

In step S1217, the printer driver 1103 checks whether the processing selected by the user is the item PRINT IMAGE WITH NORMAL TONER. In a case where the printer driver 1103 determines that the processing selected by the user is the item PRINT IMAGE WITH NORMAL TONER (YES in step S1217), the processing proceeds to step S1218. In a case where the printer driver 1103 determines that the processing selected by the user is not the item PRINT IMAGE WITH NORMAL TONER (NO in step S1217), the processing proceeds to step S1220.

In step S1218, the printer driver 1103 notifies the user of a result of the adjustment on the display (not illustrated) of the PC 1000.

In step S1219, the printer driver 1103 instructs the image forming apparatus 102 to performs normal printing.

In step S1220, the printer driver 1103 notifies the user of a result of the adjustment on the display (not illustrated) of the PC 1000 and instructs the image forming apparatus 102 to perform normal printing.

As described above, according to the present embodiment, the image or print setting for a job having a specified restriction is able to be automatically or selectively adjusted so that the job is processed as a job satisfying the specified restriction condition. With this configuration, the user is prevented from unintentionally entering a job not satisfying a specified restriction condition, which leads to implementation of an operation with an expectation for efficient reuse of sheets by a color erasing apparatus.

While, in the present example, data rendered in the raster mode is analyzed and calculated, data may be calculated based on a drawing instruction received by the printer driver 1103. More specifically, the printer driver 1103 checks for each page whether any piece of data with the image or graphic attribute in the printed information received from the DDI has a length exceeding 3 cm. For example, with respect to the DrvStretchBlt function as a DDI function for Windows-based printer drivers, an image drawing instruction can specify a square region with four positions, top, bottom, right, and left. Based on the drawing instruction, a horizontal length is calculated from the positions of right and left and the vertical length from the positions of top and bottom.

The first embodiment has been described above centering on an example where the image adjustment is performed in the main body of the image forming apparatus 102. A third embodiment will be described below centering on an example case in which there is an option for a user who does not always wish the image adjustment. Differences from the first embodiment will be described below. Similar components to those according to the first embodiment will be assigned the same reference numerals, and the redundant detailed descriptions will be omitted.

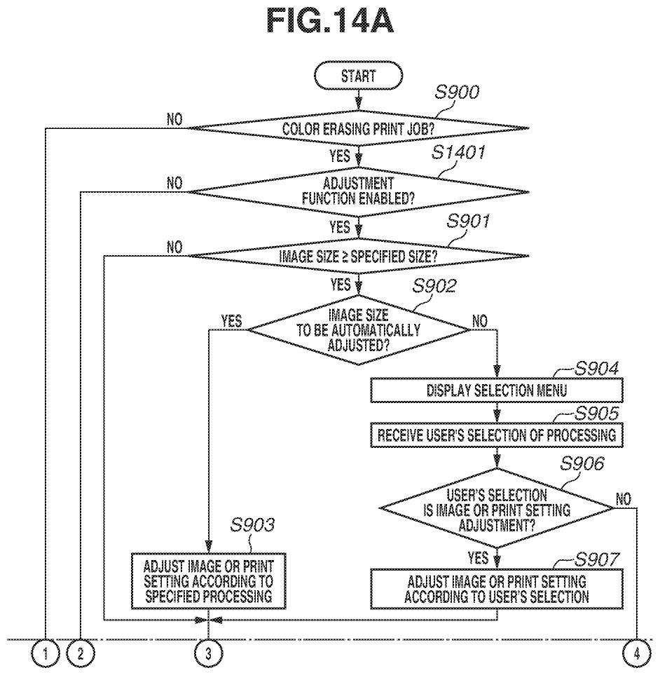

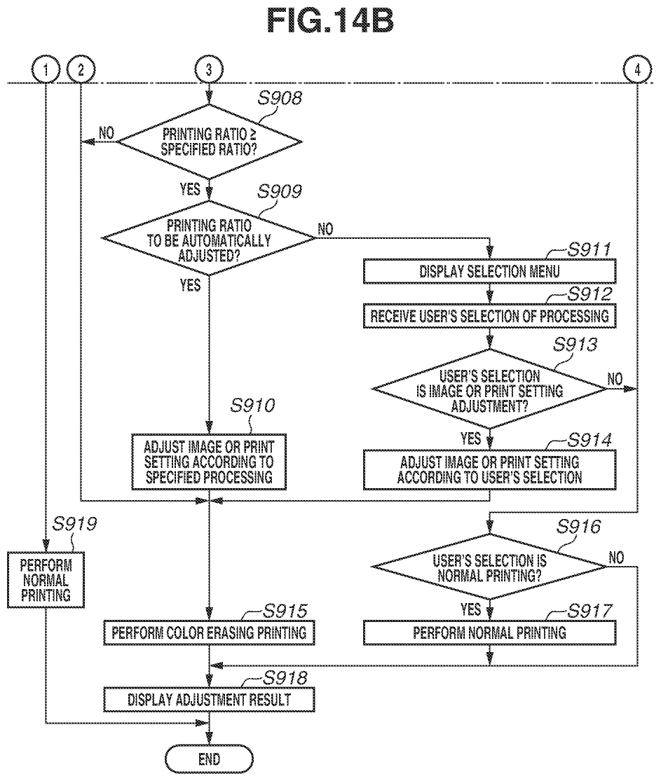

FIG. 14 is a diagram illustrating an example of a control flowchart of the image adjustment and user notification that are performed in the main body of the image forming apparatus 102.

In step S900, the CPU 121 causes the image processing unit 208 to check whether the print job has a color erasing print setting. In a case where the image processing unit 208 determines that the print job has a color erasing print setting (YES in step S900), the processing proceeds to step S1401. In a case where the image processing unit 208 determines that the print job does not have a color erasing print setting (NO in step S900), the processing proceeds to step S919.

In step S1401, the CPU 121 checks whether an adjustment function is enabled. The adjustment function may be enabled by a license or a user setting. In a case where the CPU 121 determines that an adjustment function is enabled (YES in step S1401), the processing proceeds to step S901. In a case where the CPU 121 determines that an adjustment function is not enabled (NO in step S1401), the processing proceeds to step S915 without the image adjustment. Steps S901 to S915 are similar to those in FIG. 9, and the redundant descriptions will be omitted.

The second embodiment has been described above centering on an example case in which the image adjustment is performed in the PC 1000. The present embodiment will be described below centering on an example case in which there is an option for a user who would rather not wish the image adjustment. Differences from the second embodiment will be described below. Similar components to those according to the second embodiment will be assigned the same reference numerals, and the redundant detailed descriptions will be omitted.

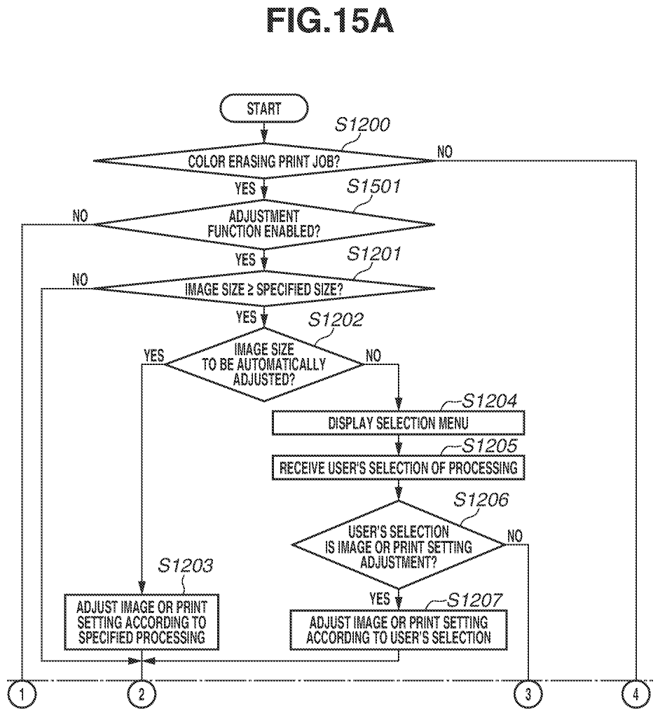

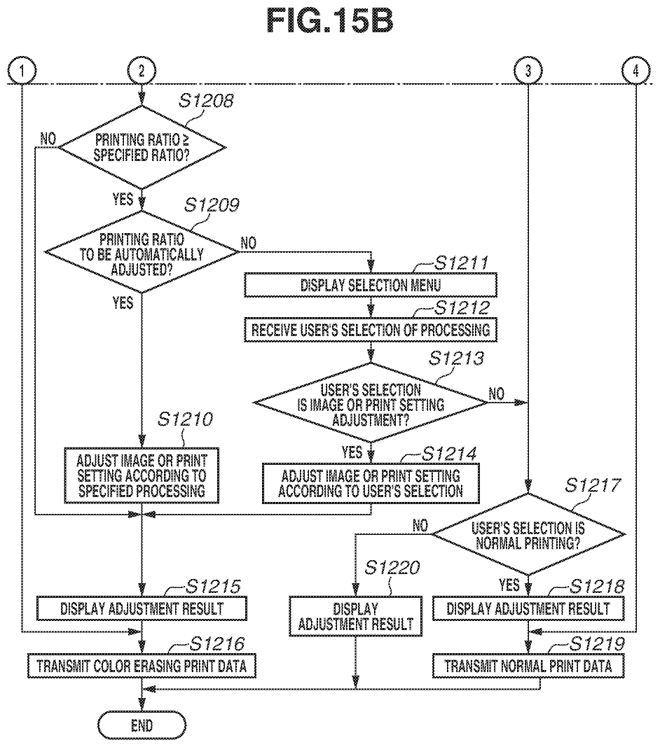

FIG. 15 is a diagram illustrating an example of a control flowchart of the image adjustment and user notification that are performed in the PC 1000.

In step S1200, the printer driver 1103 checks whether to add the setting of the color erasing print function to the print job. In a case where the printer driver 1103 determines to add the setting of the color erasing print function to the print job (YES in step S1200), the processing proceeds to step S1501. In a case where the printer driver 1103 determines not to add the setting of the color erasing print function to the print job (NO in step S1200), the processing proceeds to step S1219.

In step S1501, the printer driver 1103 checks whether the adjustment function is enabled. The adjustment function may be enabled by a license or a user setting. In a case where the printer driver 1103 determines that the adjustment function is enabled (YES in step S1501), the processing proceeds to step S1201. In a case where the printer driver 1103 determines that the adjustment function is not enabled (NO in step S1501), the processing proceeds to step S1216 without the image adjustment. Steps S1201 to S1216 are similar to those in FIG. 12, and the redundant descriptions will be omitted.

### Other Embodiments

Although various examples and embodiments of the present disclosure have been described, the spirit and scope of the present disclosure are not limited to the specific descriptions in the present specification.

The present disclosure can also be realized by processing in which a program for realizing one or more functions of the above-described embodiments is supplied to a system or an apparatus via a network or a storage media, and one or more processors in a computer of the system or the apparatus read and execute the program. The present disclosure can also be realized by a circuit (for example, ASIC) that realizes one or more functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of priority from Japanese Patent Application No. 2023-054864, filed Mar. 30, 2023, which is hereby incorporated by reference herein in its entirety.

What is claimed is:

1. An image forming apparatus capable of performing color erasing print processing using a color erasable recording material, the image forming apparatus comprising:
a receiving interface (IF) configured to receive a print job;
a notification IF configured to notify of information; and
a controller having one or more processors which executes instructions stored in one or more memories, the controller being configured to:
cause, in a case where the receiving IF has received a print job for the color erasing print processing, and a printing content of print data contained in the print job for the color erasing print processing does not satisfy a condition, the notification IF to notify of a warning for the color erasing print processing.

2. The image forming apparatus according to claim 1, wherein, in execution of the print job for the color erasing print processing, the controller performs adjustment such that the printing content satisfies the condition.

3. The image forming apparatus according to claim 2, wherein, in execution of the print job for the color erasing print processing, the controller selects an adjustment content and performs adjustment based on the selected adjustment content such that the printing content satisfies the condition.

4. The image forming apparatus according to claim 1, wherein, in a case of the notification of the warning and in response to selection of print processing using a non-color erasable recording material, the controller performs print processing without performing the color erasing print processing.

5. The image forming apparatus according to claim 1, wherein, in a case of the notification of the warning and in response to selection of cancellation of the print job, the controller performs cancellation of the print job for the color erasing print processing.

6. The image forming apparatus according to claim 3, wherein the controller receives a selection from a user in response to the warning by the notification IF and performs selection of the adjustment content based on the received selection.

7. The image forming apparatus according to claim 1,
wherein the condition is an image size of the printing content, and
wherein in a case where the image size exceeds a predetermined size, the notification IF notifies of a warning for the color erasing print processing.

8. The image forming apparatus according to claim 7,
wherein the controller calculates a printing ratio based on image region information in the print data and a sum total value of drawing target data,
wherein the condition is a printing ratio, and
wherein the notification IF notifies of, in a case where the printing ratio exceeds a predetermined ratio, a warning for the color erasing print processing.

9. The image forming apparatus according to claim 1, wherein the notification IF is a display.

10. An image forming system comprising:
a notification IF configured to notify of information; and
a controller configured to generate a print job having a setting of color erasing print processing using a color erasable recording material,
wherein, in generation of the print job having a setting of the color erasing print processing by the controller, the controller causes, based on a fact that a printing content of print data contained in the print job does not satisfy a condition, the notification IF to notify of a warning for the color erasing print processing.

11. The image forming system according to claim 10, wherein, in generation of the print job having a setting of the color erasing print processing, the controller performs adjustment such that the print content satisfies the condition.

12. The image forming system according to claim 11, wherein, in generation of the print job having a setting of the color erasing print processing, the controller selects an adjustment content and performs adjustment based on the selected adjustment content such that the print content satisfies the condition.

13. The image forming system according to claim 12, wherein, in a case where a print job having a setting of the color erasing print processing is to be generated, the controller generates, in response to selection of normal print processing using a non-color erasable recording material, a print job having a setting of the normal print processing without generating the print job having a setting of the color erasing print processing.

14. The image forming system according to claim 12, wherein, in a case where the print job having a setting of the color erasing print processing is to be generated, the controller does not, in response to selection of cancellation of the print job, generate the print job having a setting of the color erasing print processing.

15. The image forming system according to claim 12, wherein the controller receives a selection from a user in response to the warning by the notification IF and performs selection of the adjustment content based on the received selection.

16. The image forming system according to claim 10,
wherein the print content is an image size contained in the print data, and
wherein the notification IF notifies of, based on a fact that the image size exceeds a predetermined size, a warning for the color erasing print processing.

17. The image forming system according to claim 16,
wherein the controller calculates a printing ratio based on image region information in the print data and a sum total value of drawing target data,
wherein the print content is the printing ratio, and
wherein the notification IF notifies of, based on a fact that the printing ratio exceeds a predetermined ratio, a warning for the color erasing print processing.

18. The image forming system according to claim 10, wherein the notification IF is a display.
